(19) United States
(12) Patent Application Publication
(10) Pub. No.: US 2005/0166050 A1
(43) Pub. Date: Jul. 28, 2005

(54) Encoded data receiving device and method for updating decoding keys

(75) Inventor: Makoto Kosaki, Kasugai (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/088,939

(22) Filed: Mar. 25, 2005

Related U.S. Application Data
(63) Continuation of application No. PCT/JP03/06436, filed on May 22, 2003.

(51) Int. Cl. H04L 9/00; H04N 7/167

(52) U.S. Cl. 713/171; 380/201; 726/26

(57) ABSTRACT

It is an object to provide an encoded data receiving device and a method for updating a decoding key represented by DTCP standards capable of eliminating shifts in update timings of the public key NC between a data receiving device and a data transmitting device without increasing the amount of packets for inquiries between both devices. In the check portion, success or failure in data decoding is checked on the basis of fixed information that are disposed at specified bit positions of decoded data. In the determination portion, when check results indicating that decoding of data has failed are consecutively output by the check portion by a specified number of times, a determination signal indicating that update of the decoding key following update of the encoding key of the data transmitting device has failed is output whereupon a calculating portion performs update of the decoding key on the basis of the determination signal.

### CROSS-REFERENCE TO RELATED APPLICATIONS

This application is a continuation application based upon and claims the benefit of the prior PCT International Patent Application No. PCT/JP2003/006436 filed on May 22, 2003, the entire contents of which are incorporated herein by reference.

### BACKGROUND OF THE INVENTION

1. Field of the Invention

The present invention relates to an encoded data receiving device and a method for updating decoding keys, the encoded data receiving device and method for updating decoding keys being capable of eliminating failure in updates of decoding keys at an early stage.

2. Description of Related Art

In recent years, there is a standard for digital electric household appliances called Digital Transmission Content Protection Standard (hereinafter referred to as “DTCP standard”) as a method for sending and receiving data such as MPEG data in encoded manner to high-speed serial digital transmission paths such as IEEE1394 buses or USB buses. A technique as disclosed in Non-patent Document 1 in connection with the DTCP standard will be explained as prior art on the basis of FIG. 5.

According to this method, a data transmitting device and a data receiving device mutually perform authentications, and in case the authentications turn out to be successful, an authentication key Kauth is shared. The data transmitting device utilizes this authentication key Kauth for encoding an exchange key Kx to create an encoded exchange key Ksx, and this is sent to the data receiving device that has passed authentication. Upon receipt of the encoded exchange key Ksx, the data receiving device utilizes its own authentication key Kauth to obtain the original exchange key Kx. In this manner, the data receiving device that has been successful in authentication shares the exchange key Kx with the data transmitting device.

Further, a public key Nonce for Content Channel (hereinafter referred to as “public key NC”) is provided on the data transmitting device side. On the data transmitting device side, calculation is performed by utilizing both keys, that is, the exchange key Kx and the public key NC for creating a new key, that is, an encoding and decoding key Kc. By this encoding and decoding key Kc, data to be transmitted are encoded and transmitted to the data receiving device.

For purpose of safety, the data transmitting device sequentially updates the encoding and decoding key Kc from key Kc(1)to keyKc(2), keyKc(3), . . . inaperiodicmanner (intervals of 30 seconds to 2 minutes), wherein this is realized by updating the public key NC from key NC(1) to key NC(2), key NC(3) . . . . Since it is necessary to perform synchronous update of the encoding and decoding key Kc between the data transmitting device and the data receiving device, the data transmitting device needs to transmit update timings for the public key NC to the data receiving device.

According to the DTCP standard, packets to be transmitted include information indicative of the type of the currently used public key NC. There are two types for the public key NC, that is, “odd” and “even”, depending on whether the least significant bit of the public key NC is “0” or “1”. The data receiving device side observes changes in information indicative of the type of the public key NC included in the packets, and by updating the public key NC in the presence of a change, the encoding and decoding key Kc is sequentially updated. As a result, update of the encoding and decoding key Kc is performed synchronously between the data transmitting device and the data receiving device.

Further, the DTCP standard prescribes a method for inquiring the currently used type of public key NC from the data receiving device side to the data transmitting device side in performing communication of encoded data. In currently available devices, such inquiries are made once in every few seconds for performing confirmation or update of the public key NC.

If an error should occur in that the data receiving device side cannot follow up with an update of the public key NC that has been made on the data transmitting device side, the data receiving device will fail to decode data. In order to return to normal, the data receiving device side needs to inquire the type of the public key NC to the data transmitting device side and to equalize with the update of the public key NC on the data transmitting device side. Decoding of data will continuously result in failure unless the update of the public key KC has been equalized with.

The Non-patent Document 1 is indicated below as a prior art document.

Shinji Takada, “High-speed Digital Interface IEEE1394 Application to AV Appliances”, The Nikkan Kogyo Shimbun, p.133-149.

In the currently employed method of inquiring the public key NC every few seconds, inquiry packets needs to be sent to the communication path each time an inquiry is made. It causes problems that communication paths such as IEEE1394 buses or USB buses that need to be utilized for a variety of purposes are accordingly burdened.

In a method of correcting shifts in update timings of the public key NC between the receiving device and the transmitting device upon inquiry from the receiving device, since data decoding will continuously result in failure during a period from occurrence of a shift in update timing up to inquiry, disturbances of motion images and sounds will be caused. Particularly in case of motion images, since motion images are usually created by approximately 30 images switching within a single second, a failure in data decoding of several seconds will already result in deep effects and is thus problematic.

The present invention has been made for solving at least one of the above-described problems of the prior art, and it is an object thereof to provide an encoded data receiving device and a method for updating decoding keys with which it is possible to eliminate shifts in update timings for public keys NC between a data receiving device and a data transmitting device at an early stage without increasing amounts of packets related to inquiries between both devices.

### SUMMARY OF THE INVENTION

The encoded data receiving device and the method for updating decoding keys that have been made to achieve the above object is a encoded data receiving device and a method for updating decoding keys in which transmitted packets, which include data encoded by an encoding key that is updated at specified time intervals and update information of the encoding key, are received and in which the data are decoded by a decoding key that is updated on the basis of the update information.

The encoded data receiving device or the method for updating decoding keys includes a check portion or a check step for checking success or failure of data decoding, and a determination portion or a determination step for determining failure in update of the decoding key on the basis of the fact that check results indicating failure of data decoding are consecutively output by a specified number of times by the check portion or the check step.

The encoding keys and decoding keys are keys necessary for encoding and decoding data. While the same key is usually employed as the encoding key and the decoding key, they do not need to be identical as long as there exists a specified relationship between both keys. In this respect, data that have been encoded using a particular encoding key can only be decoded by a decoding key that is correlated to the encoding key.

In this manner, failure in update of the decoding key is detected by the check portion and the determination portion, and update of the decoding key is performed. Alternatively, failure in update of the decoding key is detected by the check step and the determination step, and update of the decoding key is performed. Accordingly, failure in update of the decoding key can be eliminated at an early stage also in case update conditions of the public key cannot be inquired to the data transmitting device. It is thus possible to prevent failure in communication.

Moreover, since it will no longer be necessary to inquire update conditions of the public key to the data transmitting device, it is possible to solve the problem that the communication path is burdened through packets of inquiries that are sent through the communication path. Moreover, it is possible to solve the problem of continuous failure of data decoding on the receiving device side that lead to disturbances in motion images and sounds that is caused by using the decoding key that has not been updated in the period from failure of update of the decoding key up to completion of inquiring of the update condition.

The above and further objects and novel features of the invention will more fully appear from the following detailed description when the same is read in connection with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram illustrating an arrangement of a receiving device according to a first embodiment.

FIG. 2 is a second block diagram illustrating a part of the arrangement of the receiving device according to the first embodiment.

FIG. 3 is a block diagram illustrating an arrangement of a receiving device according to a second embodiment.

FIG. 4 is a flowchart illustrating operations of the receiving device according to the second embodiment.

FIG. 5 is an explanatory diagram of DTCP standard according to the prior art.

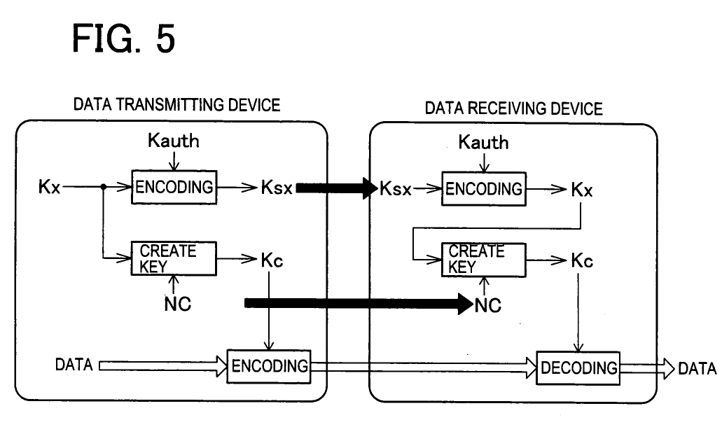

### DETAILED DESCRIPTION OF THE PREFERRED EMBODIMENTS

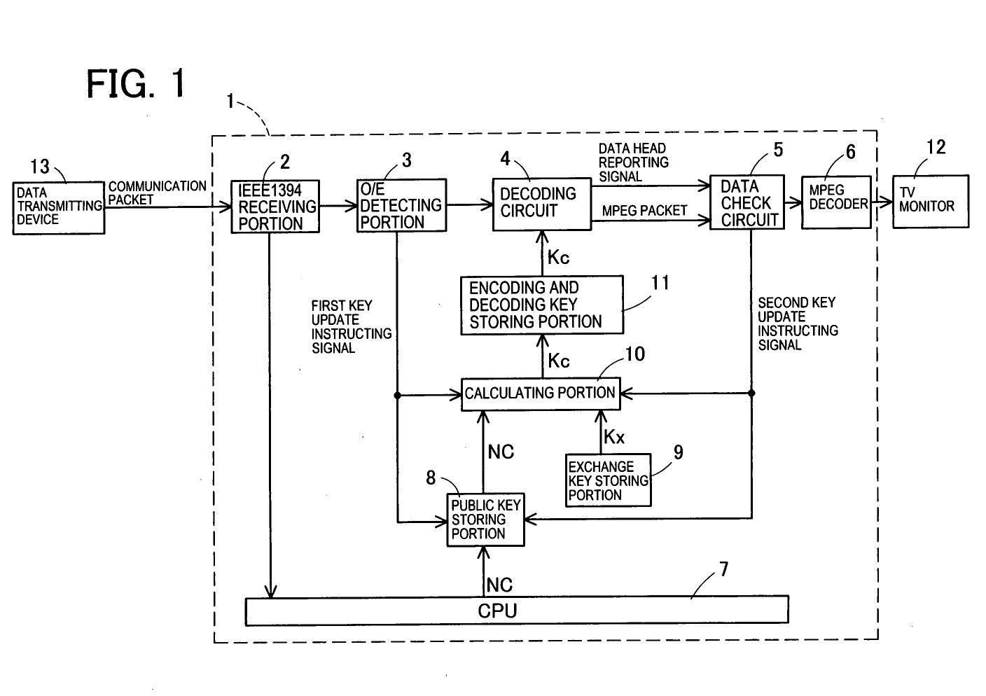

Embodiments in which the encoded data receiving device of the present invention has been embodied will now be explained in details with reference to and on the basis of FIGS. 1 to 4.

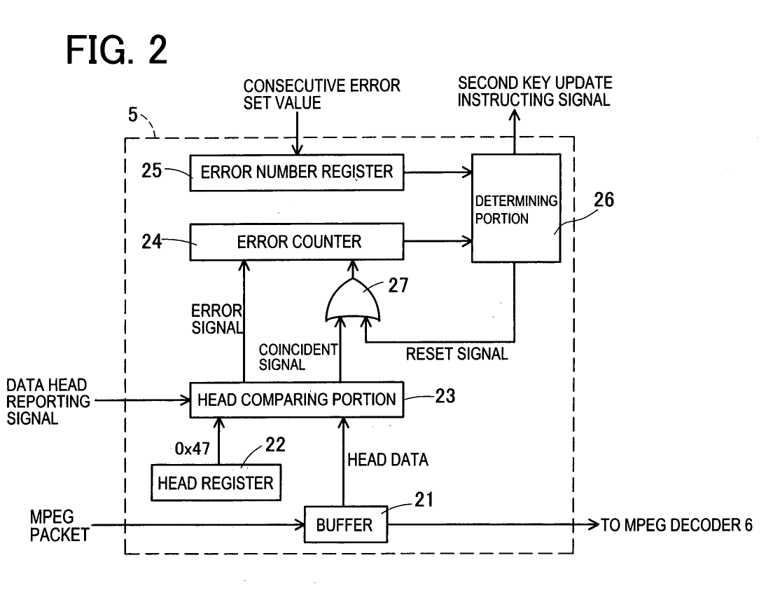

The first embodiment will be explained by using FIGS. 1 and 2. FIG. 1 is a diagram illustrating an arrangement of a receiving device according to the present invention, and FIG. 2 is a diagram illustrating an arrangement of a data check circuit.

Inside of a receiving device 1, there are sequentially connected an IEEE1394 receiving portion 2, an O/E detecting portion 3 (odd/even detecting portion, hereinafter abbreviated as “O/E detecting portion”), a decoding circuit 4, a data check circuit 5, and a MPEG decoder 6. A communication path is connected to the IEEE1394 receiving portion 2, and a TV monitor 12 is connected to the MPEG decoder 6.

A CPU 7 is connected to the IEEE1394 receiving portion 2 and a public key storing portion 8. A signal is input to the public key storing portion 8 from the O/E detecting portion 3, the data check circuit 5 and the CPU 7, and a public key is output to a calculating portion 10. A signal is input to the calculating portion 10 from the O/E detecting portion 3 and the data check circuit 5, and keys are input from the public key storing portion 8 and an exchange key storing portion 9. The calculating portion 10 then creates an encoding and decoding key Kc and outputs the same to an encoding and decoding key storing portion 11. The encoding and decoding key storing portion 11 stores the encoding and decoding key Kc and outputs the encoding and decoding key Kc to the decoding circuit 4.

In this context, the term “communication packet” indicates packet data including encoded data (wherein the data include MPEG packets) or odd/even fields. MPEG packets are packetized image data based on Moving Picture Experts Group standard (hereinafter abbreviated as MPEG). The MPEG packets are converted into image data by the MPEG decoder 6. The IEEE1394 is a serial interface standard that has been standardized by the U.S. Institute of Electrical and Electronics Engineers.

A preparatory stage for communication packet reception will first be explained.

The data receiving device 1 that has been successfully authenticated shares an exchange key Kx with a data transmitting device 13, and the exchange key Kx is stored in a register of the exchange key storing portion 9. A packet including the public key NC is sent from the data transmitting device 13 through the communication path and is input to the CPU 7 upon passing through the IEEE1394 receiving portion 2. The CPU 7 performs operations of extracting the public key NC from the packet, and the extracted public key NC is stored in a register of the public key storing portion 8.

The calculating portion 10 extracts the exchange key Kx from the exchange key storing portion 9 and the public key NC from the public key storing portion 8, and calculating processes are performed by using both keys to thus obtain an encoding and decoding key Kc. The thus obtained encoding and decoding key Kc is input to the encoding and decoding key storing portion 11 and is stored in a register of the encoding and decoding key storing portion 11.

Operations when receiving communication packets will now be explained.

A communication packet that has been sent from the data transmitting device 13 through the communication path is input to the IEEE1394 receiving portion 2 inside of the receiving device 1 and the communication packet that has been output from the IEEE1394 receiving portion 2 is input to the O/E detecting portion 3. In the O/E detecting portion 3, reversal of bit information of the odd/even field within the header of the communication packet is checked, and the communication packet is output to the decoding circuit 4.

Upon detecting of reversal of bit information in the O/E detecting portion 3, a first key update instruction signal is issued from the O/E detecting portion 3 to the public key storing portion 8 and the calculating portion 10.

In the decoding circuit 4, decoding processes of encoded data within the communication packet that is input from the O/E detecting portion 3 is performed on the basis of the encoding and decoding key Kc that is input from the encoding and decoding key storing portion 11 to thus obtain a decoded MPEG packet.

The decoded MPEG packet and a data head reporting signal indicating the head of the MPEG packet are output to the data check circuit 5.

In the data check circuit 5, success or failure of decoding of encoded data is checked on the basis of the data head reporting signal, and the MPEG packet is output to the MPEG decoder 6. When it is determined in the data check circuit 5 that the decoding process of the encoded data has failed, a second key update instruction signal is issued from the data check circuit 5 to the public key storing portion 8 and the calculating portion 10.

In the MPEG decoder 6, image data are obtained from the input MPEG packet and output to the TV monitor 12 such that motion images can be obtained on the TV monitor 12.

Operations of the O/E detecting portion 3 will now be explained.

In the data transmitting device 13 and the data receiving device 1, an encoding and decoding key Kc is created on the basis of the exchange key Kc and the public key NC, and encoding and decoding of the MPEG packet is performed by using the encoding and decoding key Kc.

For purpose of safety, the data transmitting device 13 sequentially updates the encoding and decoding key Kc from key Kc(1) to key Kc(2), key Kc(3) . . . by sequentially updating the public key NC from public key NC(1) to key NC(2), key NC(3) . . . on a periodic basis (every 30 seconds to 2 minutes). In odd/even fields of a plurality of communication packets (1), communication packets (2), communication packets (3) . . . including encoded data encoded by the encoding and decoding key Kc(1), key Kc(2), key Kc(3) . . . , bit information of least significant bits of the public keyNC(1), keyNC(2), key NC(3) . . . used in the data transmitting device 13 are stored. By detecting reversal of such bit information in the data receiving device 1, it is possible to know update timings of encoding and decoding keys Kc on the data transmitting device 13 side.

In the data transmitting device 13, a plurality of communication packets (1) including data encoded by the encoding and decoding key Kc (1) created by the public key NC(1) (wherein the least significant bit is defined as 0) is sequentially created and transmitted. At this time, bit information “0” is stored in the odd/even field of the communication packets (1). In this respect, the encoded data include MPEG packets.

At this time, in the data receiving device 1, the encoding and decoding key Kc (1), which has been calculated by the public key NC(1) that has been preliminarily received and stored in the public key storing portion 8, is stored in the encoding and decoding key storing portion 11, and encoded data included in the communication packets (1) are decoded in the decoding circuit 4 by the encoding and decoding key Kc(1).

In this respect, unless the public key NC(1) is updated, the same encoding and decoding key Kc (1) is used for sequentially transmitting communication packets (1).

Next, accompanying the update of the public key NC (1) (counted up by 1 so that the least significant bit becomes 1) to become public key NC(2) in the data transmitting device 13, the encoding and decoding key Kc (1) is similarly updated to encoding and decoding key Kc (2). A plurality of communication packets (2) that have been encoded by the encoding and decoding key Kc (2) is then sequentially created and transmitted instead of the communication packets(1) (bit information “1” is stored in the odd-even fields of the communication packets (2)).

When communication packets (2) are received by the data receiving device 1 instead of the communication packets (1), reversal of bit information from “0” to “1” in the odd/even fields included in header portions of the communication packets (2) are detected in the O/E detecting portion 3, and a first key updating instructing signal is output from the O/E detecting portion 3 to the public key storing portion 8 and the calculating portion 10.

Upon input of the first key updating instructing signal to the public key storing portion 8, update of the public key NC is performed by counting the public key NC that had been stored in the register up by 1 to become public key NC(2). Upon input of the first key update instructing signal to the calculating portion 10, calculating processes are performed in the calculating portion 10 on the basis of the updated public key NC(2) stored in the public key storing portion 8 and the exchange key Kx stored in the exchange key storing portion 9 to obtain updated encoding and decoding key Kc (2). The encoding and decoding key Kc (2) is input and stored in the register of the encoding and decoding key storing portion 11. With this arrangement, update of encoding and decoding key Kc of the data receiving device 1 is performed in accordance with the update of the encoding and decoding key Kc of the data transmitting device 13.

In the decoding circuit 4, decoding processes of encoded data within communication packets (2) that are input from the O/E detecting portion 3 are performed on the basis of the encoding and decoding key Kc (2) input from the encoding and decoding key storing portion 11 to thus obtain decoded MPEG packets.

In this manner, it will be possible to update the encoding and decoding key Kc of the data receiving device 1 in accordance with communication packets including data that have been encoded by the encoding and decoding key Kc that has been updated in the data transmitting device 13 so that it is possible to perform decoding of encoded data by a suitable key.

Operations of the data check circuit 5 will now be explained.

In the data check circuit 5, it is checked whether decoding of the encoded data has been successfully performed or not on the basis of the decoded MPEG packets input from the decoding circuit 4 and the data head reporting signal. It is then determined whether update of the encoding and decoding key Kc of the data receiving device 1 has been performed or not following the update of the encoding and decoding key Kc of the data transmitting device 13.

A condition in which update of the encoding and decoding key Kc of the data transmitting device 13 cannot be followed occurs when reversal of bit information of the odd/even field of the communication packets cannot be recognized by the data receiving device 1 owing to abnormalities of the communication path when the encoding and decoding key Kc (2) of the data transmitting device 13 is updated to key Kc(3), and the communication packets to be transmitted change from communication packets (2) to communication packets (3). At this time, since the data receiving device 1 tries to decode communication packets (3), which include data that have been encoded in the data transmitting device 13 by using the encoding and decoding key Kc(3), by using the encoding and decoding key Kc(2) prior to updating, decoding of the encoded data will fail.

When it is determined that that no update of the encoding and decoding key Kc of the data receiving device 1 has been performed following the update of the key in the data transmitting device 13, a second key update instruction signal is sent from the data check circuit 5 to the public key storing portion 8 and the calculating portion 10.

Upon input of the second key update instruction signal to the public key storing portion 8, update of the public key NC is performed by counting the public key NC, which had been stored in the register, by one. Upon input of the second key update instruction signal to the calculating portion 10, calculating processes are performed in the calculating portion 10 on the basis of the updated public key NC that is stored by the public key storing portion 8 and the exchange key Kx that is stored by the exchange key storing portion 9 to obtain an updated encoding and decoding key Kc that is then input to and stored in the register of the encoding and decoding key storing portion 11. With this arrangement, an encoding and decoding key Kc corresponding to the data transmitting device 13 is set in the data receiving device 1.

A circuit arrangement of the data check circuit 5 will now be explained by using FIG. 2.

The data check circuit 5 is comprised with a buffer 21, a head register 22, a head comparing portion 23, an error counter 24, an error number register 25, and a determining portion 26.

The head register 22 stores data “0x47” that is being defined as the head of a MPEG packet in conformity with standards.

The MPEG packets that are input from the decoding circuit 4 to the data check circuit 5 are sent to the MPEG decoder 6 through the buffer 21. The head data of the MPEG data input to the buffer 21 are input to the head comparing portion 23. Data head data from the buffer 21, “0x47” from the head register 22, and a data head reporting signal output from the decoding circuit 4 are input to the head comparing portion 23, respectively.

The head comparing portion 23 takes in head data of MPEG packets in accordance with the data head reporting signal through the buffer 21.

Here, the head data of MPEG packets are always “0x47” as defined by standards. Since MPEG packets are obtained through decoding of encoded data in the decoding circuit 4, in the presence of a failure in decoding in the decoding circuit 4, the head data of the MPEG packets that are input to the data check circuit 5 do not necessarily become “0x47”.

Accordingly, the head data that have been taken in and the data head “0x47” stored in the head register 22 are compared in the head comparing portion 23, and if both members should not coincide, an error signal is sent to the error counter 24.

In the error counter 24, the consecutive number of times that MPEG packets of which decoding has failed are consecutively input to the data check circuit 5 is counted. In other words, when a MPEG packet of which decoding has been successful is input to the data check circuit 5, a coincident signal indicating that the comparison results are coincident is output from the head comparing portion 23 and is input to the error counter 24 through an OR gate 27. The error counter 24 is then reset.

The error number register 25 preliminarily stores a consecutive error set value by which a second key update instruction signal is output upon judging that update of the encoding and decoding key Kc has failed.

In the determining portion 26, the consecutive number of errors, which is an output of the error counter 24, and a consecutive error set value, which is an output of the error number register 25, are compared, and when the consecutive number of errors is the consecutive error set value, the second key update instruction signal is output and a reset signal is output. The reset signal is input to the error counter 24 through the OR gate 27, and the error counter 24 is reset by the reset signal.

With this arrangement, since failure in update of the encoding and decoding key Kc is detected by the head comparing portion 23 and the determining portion 26 and update of the encoding and decoding key Kc is performed by the calculating portion 10 after update of the public key NC, failure in update of the encoding and decoding key Kc can be eliminated at an early stage also in case update conditions of the encoding and decoding key Kc are not inquired to the data transmitting device 13. It is thus possible to eliminate failures in data communication at an early stage.

Moreover, since update conditions of the encoding and decoding key Kc need not be inquired to the data transmitting device 13, it is possible to solve the problem of burdening the communication path by sending inquiry packets to the communication path. Further, it is possible to solve the problem of occurrence of disturbances in motion images and sound that is caused through continuous failure in decoding of encoded data on the data receiving device side by using the not-updated encoding and decoding key Kc in a period from failure of update in encoding and decoding key Kc up to completion of inquiry of the update condition.

In the encoded data receiving device 1 according to the first embodiment, failure in update of the encoding and decoding key Kc is detected in the data check circuit 5, and update of the encoding and decoding key Kc is performed in the calculating portion 10. With this arrangement, failure in update of the encoding and decoding key Kc can be eliminated at an early stage also in case of handling motion image data that are largely affected already by a short-termed period of continuous failure of decoding of encoded data such that failure in communication of image data can be eliminated at an early stage, and it is possible to restrict occurrences of disturbances in images or the like.

In the encoded data receiving device 1 according to the first embodiment, success or failure in decoding of encoded data is checked by whether the head of the MPEG packet is “0x47” or not, and when check results indicating failure of decoding of encoded data are consecutively output by a specified number of times by the head comparing portion 23, a second key update instruction signal indicating failure of update of the encoding and decoding key Kc is sent from the determining portion 26 to the public key storing portion 8 and the calculating portion 10, and the encoding and decoding key Kc is updated in the calculating portion 10.

With this arrangement, failure in update of the encoding and decoding key Kc can be eliminated at an early stage also in case of handling motion image data that are largely affected already by a short-termed period of continuous failure of decoding of encoded data such that failure in communication of data can be eliminated at an early stage, and it is possible to restrict occurrences of disturbances in images or the like.

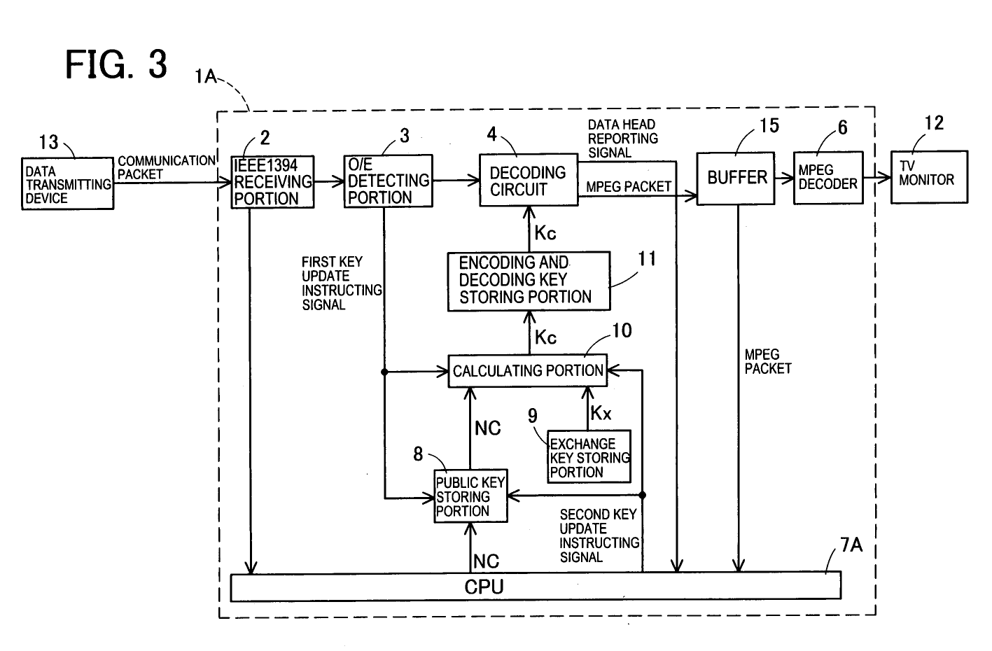

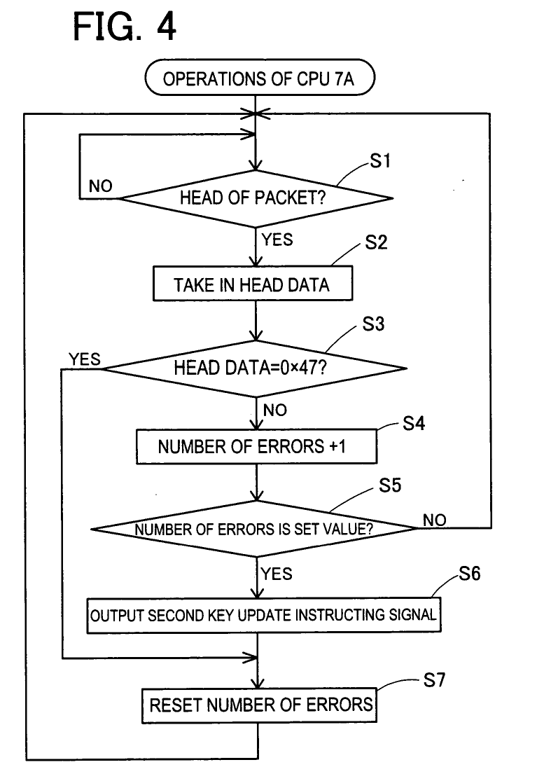

A second embodiment will now be explained by using FIGS. 3 and 4. FIG. 3 is a diagram illustrating a structure of a receiving device 1A according to the second embodiment, and FIG. 4 is a flowchart of data check operations performed in a CPU 7A.

When compared with the arrangement of the receiving device 1 according to the first embodiment, the receiving device 1A is arranged such that it is provided with a buffer 15 instead of the data check circuit 5 and in which operations similar to those of the data check circuit 5 are performed in a CPU 7A.

MPEG packets output from the decoding circuit 4 are input to the MPEG decoder 6 and the CPU 7A through the buffer 15, and a data head reporting signal output from the decoding circuit 4 is input to the CPU 7A. A second key update instruction signal is output from the CPU 7A and is input to the public key storing portion 8 and the calculating portion 10. Since the remaining arrangements are similar to those of the receiving device 1 according to the first embodiment, explanations thereof will here be omitted.

Operations of the CPU 7A will now be explained. The CPU 7A checks whether decoding of encoded data in the decoding circuit 4 has been successful on the basis of the MPEG packet input from the buffer 15 and the data head reporting signal. It is then determined whether update of the encoding and decoding key Kc of the data receiving device 1A has been performed following the update of the encoding and decoding key Kc of the data transmitting device 13, and when it is determined that it has not been updated, a second key update instruction signal is output from the CPU 7A to the public key storing portion 8 and the calculating portion 10 for updating the encoding and decoding key Kc.

The method for checking, in the CPU 7A, whether decoding of encoded data has been successfully performed or not will now be explained by using FIG. 4. The CPU 7A preliminarily stores data “0x 47”, which are head data of MPEG packets, a number of errors “0 times” for decoding of encoded data, and “2 times” for a consecutive error set value, respectively.

In this respect, as for the number of errors, the consecutive number of times that MPEG packets in which decoding has failed are consecutively input to the CPU 7A is counted. Upon input of a MPEG packet that has been successfully decoded, the number of errors is reset to “0”.

The flowchart of FIG. 4 will now be explained.

In Step S1, it is observed and determined in the CPU 7A whether the head of the MPEG packet has been input to the CPU 7A or not. This determination is made on the basis of the data head reporting signal that is input to the CPU 7A. When it is determined that the head data has been input to the CPU 7A (S1: YES), the head data of the MPEG packet is taken in Step S2 whereupon the program proceeds to Step S3.

In Step S3, comparison of data “0x47” preliminarily stored in the CPU 7A and the head data that has been taken in in Step S2 is performed, and when both coincide (S3: YES), it is determined that decoding of encoded data has been successfully performed so that the program proceeds to Step S7. The number of errors is then reset in Step S7, and the program returns to Step S1 to continue observations. When both do not coincide (S3: NO), it is determined that decoding of encoded data has failed so that the program proceeds to Step S4.

In Step S4, the number of errors stored in the CPU 7A is incremented by 1 and the program proceeds to Step S5.

In Step S5, the number of errors stored in the CPU 7A and the consecutive error set value are compared. When the number of errors is less than the consecutive error set value (S5: NO), the program returns to S1 and observations are continued. When the number of errors has becomes the consecutive error set value “2 times” (S5: YES), it is deemed that update of the encoding and decoding key Kc of the data receiving device 1A has failed, and the program proceeds to Step S6.

In Step S6, a second key update instruction signal is output from the CPU 7A to the public key storing portion 8 and the calculating portion 10, and the program proceeds to Step S7.

Upon input of the second key update instruction signal to the public key storing portion 8, the public key NC that had been stored in the register is counted up by one to thus update the public key NC. Since the key update instruction signal is simultaneously input to the calculating portion 10, calculating processes are performed in the calculating portion 10 on the basis of the updated public key NC stored in the public key storing portion 8 and the exchange key Kx stored in the exchange key storing portion 9 to thus obtain an updated encoding and decoding key Kc that is input and stored in the register of the encoding and decoding key holding portion 11.

In Step S7, the number of errors is reset to “0 times” whereupon the program returns to Step S1 and continues observations.

With this arrangement, since failure in update of the encoding and decoding key Kc is detected by the CPU 7A to perform update, it is possible to eliminate failure in update of the encoding and decoding key Kc at an early stage also in case update conditions of the encoding and decoding key Kc are not inquired to the data transmitting device 13.

Further, by using the CPU 7A instead of the data check circuit 5, the data check circuit 5 will not be required so that it is possible to, for instance, reduce the circuit area of the data receiving device 1A.

In this respect, the present invention is not limited to the above embodiments alone, and it goes without saying that various improvements and modifications without departing from the gist of the present invention are possible.

For instance, while “2 times” is employed as a value for the consecutive error set value in the second embodiment, it goes without saying that this set value may be suitably changed. In this respect, the consecutive error set value is set in accordance with required image quality or the like, and in case of handling relatively simple motion images such as animations, it is preferable to employ a smaller value for the consecutive error set value since disturbances in motion images owing to failure in decoding of encoded data are obvious to viewing audiences.

While data to be encoded are illustrated as to be MPEG packets, which are motion image data in the present embodiments, it goes without saying that the present invention is similarly applicable to other data such as sound data or still image data.

Further, while the present embodiments have been illustrated on the basis of a case in which encoding and decoding of data is performed in conformity with DTCP standards, it goes without saying that other standards are similarly applicable.

### INDUSTRIAL APPLICABILITY

According to the present invention, no packets for inquiring update conditions of public keys need to be sent to the communication path so that the communication path is not burdened. Moreover, disturbances in motion images or sound can be eliminated at an early stage since failure in data decoding will not continue on the receiving device side by using non-updated decoding keys during periods from failure in update of decoding keys up to completion of inquiries of update conditions.

1. An encoded data receiving device in which transmitted packets, which include data encoded by an encoding key that is updated at specified time intervals and update information of the encoding key, are received and in which the data are decoded by a decoding key that is updated on the basis of the update information, the device comprising:
a check portion for checking success or failure of data decoding, and
a determination portion that outputs a determination signal of failure in update of the decoding key in accordance with the fact that check results indicating failure of data decoding are consecutively output by a specified number of times by the check portion,
wherein update of the decoding keys is performed on the basis of the determination signal.

2. The encoded data receiving device as claimed in claim 1, wherein encoding and decoding of the data is performed in conformity with DTCP standards.

3. The encoded data receiving device as claimed in claim 1, wherein success or failure of data decoding is checked by the check portion on the basis of fixed information disposed at specified bit positions of the decoded data.

4. The encoded data receiving device as claimed in claim 3, wherein the fixed information are “0x47” of a data header when the data are MPEG data.

5. A method for updating decoding keys in which transmitted packets, which include data encoded by an encoding key that is updated at specified time intervals and update information of the encoding key, are received and in which the data are decoded by a decoding key that is updated on the basis of the update information, the method including:
a check step for checking success or failure of data decoding, and
a determination step that determines failure in update of the decoding key in accordance with the fact that check results indicating failure of data decoding are consecutively output by a specified number of times by the check step,
wherein update of the decoding keys is performed on the basis of the determination of failure in update of the decoding by the determination step.

6. The method for updating decoding keys as claimed in claim 5, wherein encoding and decoding of the data is performed in conformity with DTCP standards.

7. The method for updating decoding keys as claimed in claim 5, wherein success or failure of data decoding is checked by the check step on the basis of fixed information disposed at specified bit positions of the decoded data.

8. The method for updating decoding keys as claimed in claim 7, wherein the fixed information are “0x47” of a data header when the data are MPEG data.
